(19) United States
(12) Patent Application Publication
(10) Pub. No.: US 2005/0274249 A1
(43) Pub. Date: Dec. 15, 2005

(54) Apparatus for truncating metal structural members

(76) Inventor: Leon B. Trudeau, (US)

Correspondence Address: ONEBANE LAW FIRM, 1200 CAMELLIA BLVD., SUITE 300, LAFAYETTE, LA, 70508-6667, US

(21) Appl. No.: 11/207,487

(22) Filed: Aug. 19, 2005

Related U.S. Application Data
(63) Continuation-in-part of application No. 10/702,581, filed on Nov. 7, 2003.

(51) Int. Cl. B26D 1/08

(52) U.S. Cl. 83/636; 83/821

(57) ABSTRACT

A cutting tool for truncating elongated structural members. The cutting tool generally includes a frame, at least one cylinder having a cylinder rod, and a blade. The frame generally includes two substantially parallel side rails, a cross member extending between the side rails at one end of the side rails, and an end gate extending between the side rails at the end of the side rails opposite the cross member. At least one cylinder having a cylinder rod is secured to the cross member. The cylinder rod is attached to a blade to facilitate back and forth movement of the blade between the cylinder and the end gate. The cutting edge of the blade has the shape of a wide-angled arrow point. The end gate is equipped with a downwardly beveled cutting edge that extends toward the edge of the blade. As the blade is moved toward the end gate, the edge of the blade and the cutting edge of the end gate work together to sheer a metal structural member placed within the frame. The sheering action completely severs the metal structural member into two separate sections, despite any deformation in the metal structural member.

### CROSS REFERENCE TO RELATED APPLICATIONS

This application is a continuation-in-part of prior application Ser. No. 10/702581, filed on Nov. 7, 2003.

### BACKGROUND

1. Field of the Invention

The present invention relates generally to the truncation of elongated structural members.

2. Description of Related Art

In various industries, it is occasionally necessary to truncate elongated structural members to a desired length. For example, in the offshore petroleum industry, during the decommissioning of a drilling or production platform, it is frequently important to truncate the legs of the platform as close as possible to the sea bed. Conventional methods for performing such tasks utilize divers working with thermal cutting tools and/or explosives. These conventional methods are dangerous, time consuming, and costly.

The truncation of concrete piles using cutters is described in U.S. Pat. Nos. 5,139,006 and 5,413,086, the entire disclosures of which are incorporated herein by reference. European patent application 243,981 discloses a cutter for concrete piles which may include steel cylinders grouted with concrete.

The concrete cutters disclosed in the prior art are not suitable for cutting elongated metal structural members, including ungrouted tubular members, wide flange beams, and other elongated structural members having various cross-sectional shapes. The blades used for concrete piles do not withstand the stresses encountered in truncating metal structural members. In addition, the blades used for concrete piles cause metal structural members to deform and collapse, making it virtually impossible to sever the metal structural member into two separate sections. The incomplete severing is particularly common when attempting to truncate metal structural members that are tubular and hollow.

The present invention provides an apparatus for truncating elongated structural members of various configurations and materials, including metal structural members that are tubular and hollow.

### SUMMARY OF THE INVENTION

The present invention is a cutting tool for truncating elongated structural members. The cutting tool generally includes a frame, at least one cylinder having a cylinder rod, and a blade. The frame generally includes two substantially parallel side rails, a cross member extending between the side rails at one end of the side rails, and an end gate extending between the side rails at the end of the side rails opposite the cross member.

At least one cylinder having a cylinder rod is secured to the cross member. The cylinder rod is attached to a blade to facilitate back and forth movement of the blade between the cylinder and the end gate.

In the preferred embodiment of the present invention, the cutting edge of the blade has the shape of a wide-angled arrow point. In this embodiment, the end gate is equipped with a downwardly beveled cutting edge that extends toward the edge of the blade. As the blade is moved toward the end gate, the edge of the blade and the cutting edge of the end gate work together to sheer a metal structural member placed within the frame. The sheering action completely severs the metal structural member into two separate sections, despite any deformation in the metal structural member.

In an alternative embodiment of the present invention, the cutting edge of the blade has three sides. This alternative embodiment is another design for truncating metal structural members that are subject to lateral deformation during the truncation process. To overcome this problem, the cutting edge of the blade is recessed from the front of the blade, and two secondary cutting edges are formed on the “ears” of the blade. The secondary cutting edges provide additional cutting surfaces to ensure a complete truncation of the metal deformed structural member with no snags.

### BRIEF DESCRIPTION OF THE DRAWINGS

The invention will be better understood by reference to the accompanying drawings wherein:

FIG. 1 is a plan view of a cutting tool according to the present invention;

FIG. 2 is a side view of a cross member of the cutting tool;

FIG. 3 is a side view of a side rail of the cutting tool;

FIG. 4 is a side view of a reinforced side rail of the cutting tool;

FIG. 5 is a side view of an end gate of the cutting tool;

FIG. 6 is a side view of a cutting edge of the blade of the cutting tool;

FIG. 7 is a plan view of a blade having the shape of a wide-angled arrow point.

FIG. 8 is a plan view of a blade having three cutting edges.

FIG. 9 is an illustration of the deformation of a hollow, cylindrical structural member.

### DESCRIPTION OF THE INVENTION

FIG. 1 depicts a cutting tool 10 for truncating an elongated structural member. Cutting tool 10 generally includes a frame 11, at least one cylinder 32 having a cylinder rod 33, and a blade 28. All of these components of cutting tool 10 are preferably made of metal or some other material that is strong, rigid, and durable.

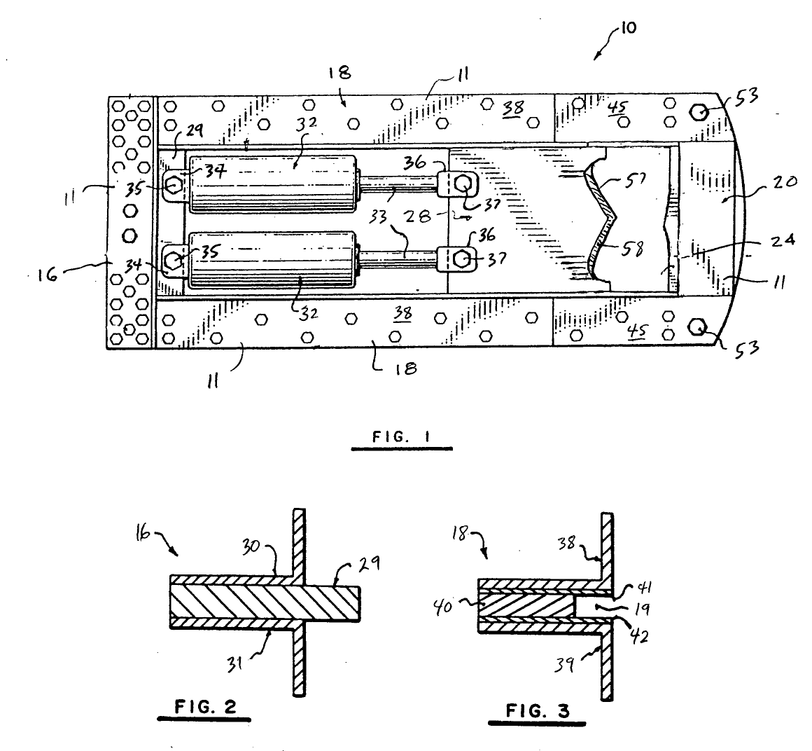

Frame 11 generally includes a cross member 16, two side rails 18, and an end gate 20. Cross member 16 preferably extends between side rails 18 and is attached to one end of both side rails 18. FIG. 2 shows a side view of cross member 16, which is preferably constructed of support plate 29 and upper angle iron 30 and lower angle iron 31.

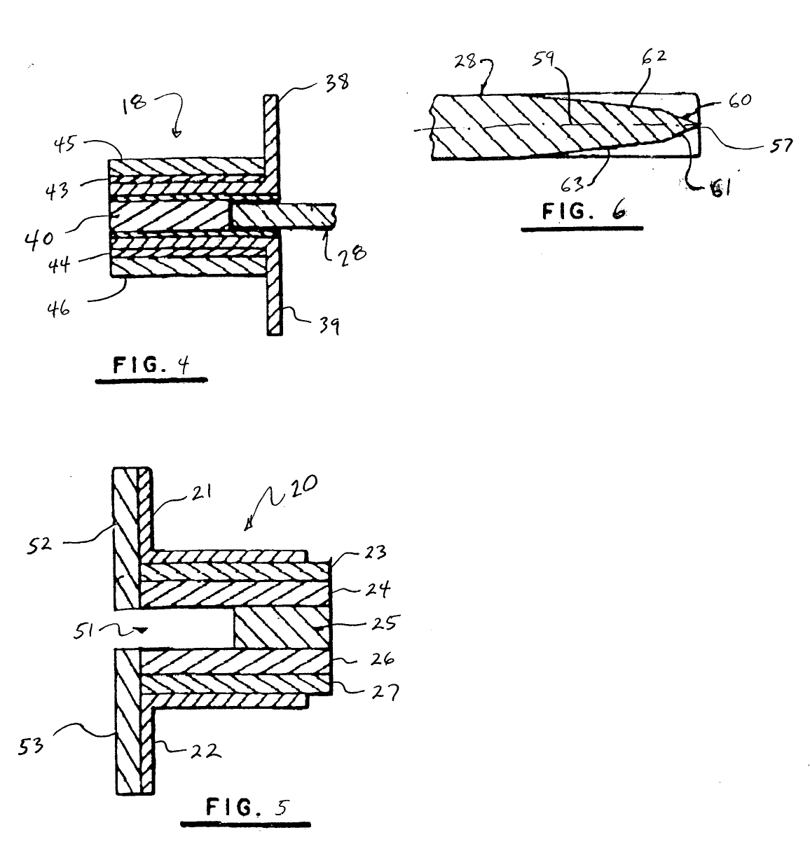

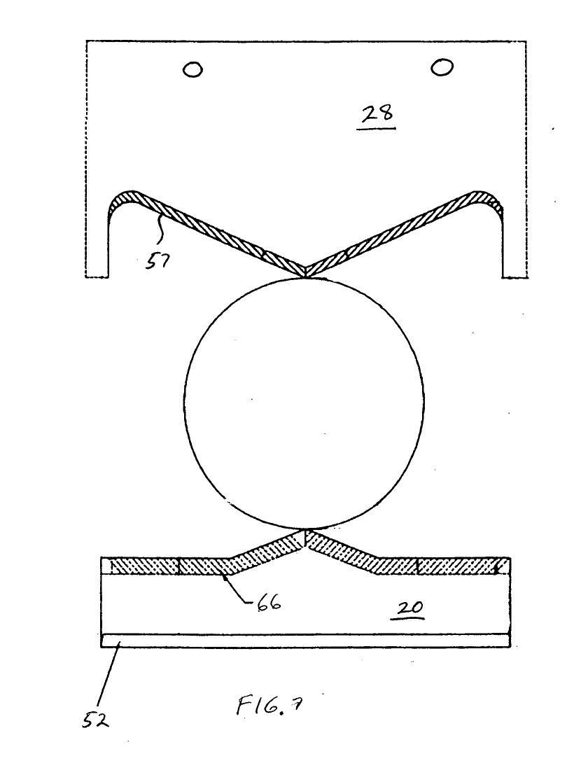

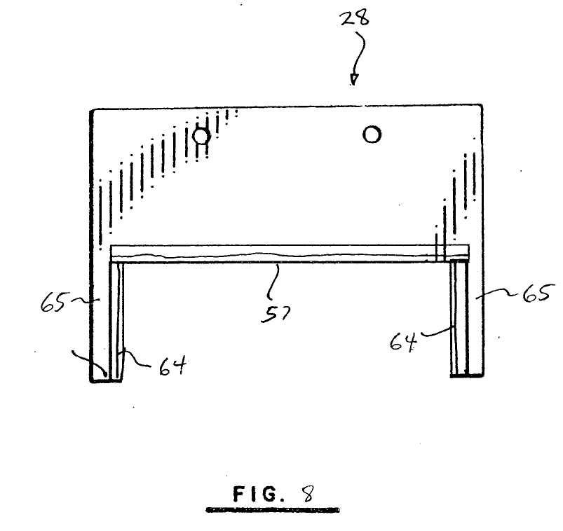

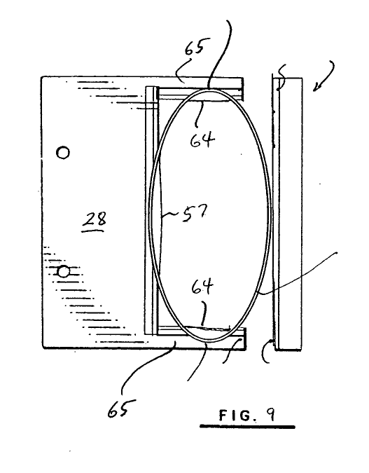

Referring to FIG. 1, side rails 18 preferably extend from cross member 16 to end gate 20. FIG. 3 shows a side view of side rail 18. Each side rail 18 has an inwardly facing channel 19 to accommodate a lateral edge of blade 28, which slides along channels 19 to and from end gate 20. Each side rail 18 includes an upper and lower angle iron 38 and 39, side plate 40, and upper and lower thin plates 41 and 42. A section of side rails 18 near end gate 20 is preferably reinforced with outer thin plates 43 and 44 and outer thick plates 45 and 46, as shown in FIG. 4.

Referring back to FIG. 1, end gate 20 preferably extends between side rails 18 and connects to each of side rails 18 on the ends opposite cross member 16. End gate 20 is preferably removably secured to side rails 18 using bolts or pins 54, which are capable of withstanding the shearing stress generated during the truncating process. In each of the embodiments discussed below, end gate 20 has a pocket 51, as shown in FIG. 5, to accommodate blade 28 during the cutting process. Pocket 51 is extends between side rails 18 and is formed by face plates 52 and 53, a set of horizontal plates 23, 24, 25, 26, and 27, and upper and lower angle irons 21 and 22.

Referring again to FIG. 1, at least one cylinder 32 is secured at one of its ends to support plate 29 using devises 34 and bolts or pins 35. FIG. 1 shows the preferred arrangement of two cylinders 32 secured to support plate 29.

Still referring to FIG. 1, a cylinder rod 33 reciprocally extends from each cylinder 32, and is attached at one end to blade 28 using devices 36 and bolts or pins 37. Changes in fluid pressure inside each cylinder 32 cause cylinder rod 33 to move in and out of cylinder 32 to facilitate back and forth movement of blade 28 along side rails 18. The total distance traveled by cylinder rod 33 can be changed to adapt to the size of the structural member to be truncated.

Blade 28 is a substantially flat metal plate extending between side rails 18 with a leading cutting edge 57 having a double bevel 58. Blade 28 must be thick enough and rigid enough not to buckle during the truncation process. The lateral edges of blade 28 are preferably thick enough to substantially fill channels 19 of side rails 18 so as to prevent dust and the like from accumulating within channels 19.

As shown in FIG. 6, cutting edge 57 and double bevel 58 are defined by the intersection of two surfaces 60 and 61 meeting at an included angle of approximately 50°, and not less than approximately 45°. A secondary bevel is defined by two surfaces 62 and 63 having an included angle of approximately 34°. The resulting double bevel 58 is symmetrical about a median plane 59, with a combined bevel depth of approximately three inches.

Cutting edge 57 is preferably made of a very hard material, such as the type of steel referred to as tool steel or tool die steel. Cutting edge 57 can also be made of tool carbides, including, for example, tungsten (wolfram) carbide, WC. As those skilled in the art will appreciate, the necessary level of hardness of the material used to make cutting edge 57 will depend on the dimension, structure, and properties of the structural member being truncated. Cutting edge 57 should be sufficiently hard to truncate several structural members without any noticeable wear to cutting edge 57.

In the preferred embodiment of the present invention, cutting edge 57 of blade 28 has the shape of a wide-angled arrow point, as shown in FIG. 7. In this embodiment, end gate 20 is equipped with a downwardly beveled cutting edge 66 that extends toward cutting edge 57 from face plate 52 immediately above pocket 51. As blade 28 is moved toward end gate 20, cutting edges 57 and 66 work together to sheer a metal structural member that may have been deformed by the force of blade 28 moving toward end gate 20. The sheering action completely severs the metal structural member into two separate sections, despite any deformation in the metal structural member.

In an alternative embodiment of the present invention, cutting edge 57 of blade 28 has three sides, as shown in FIGS. 8 and 9. This alternative embodiment is another design for truncating metal structural members that are subject to lateral deformation when acted upon as cylinders 32 push blade 28 toward end gate 20. Lateral deformation is of particular concern with smaller diameter metal structural members that are tubular and hollow where there is significant clearance between the undeformed metal structural member and side rails 18. To overcome this problem, cutting edge 57 of blade 28 is recessed from the front of blade 28, and two secondary cutting edges 64 are formed on the “ears” 65 of blade 28. Secondary cutting edges 64 are similar in cross-sectional configuration to primary cutting edge 57, as shown in FIG. 6. Secondary cutting edges 64 provide additional cutting surfaces to ensure a complete truncation of the metal deformed structural member with no snags.

While particular embodiments of the present invention have been described in the foregoing paragraphs, it is to be understood that other embodiments are possible within the scope of the invention. It is also to be understood that the invention is not limited to use in truncating hollow cylindrical members, but is useful for truncating wide flange beams and other elongated structural members having various cross-sectional shapes. The invention is therefore to be considered limited solely by the scope of the claims.

1. A cutting tool for truncating elongated structural members, said cutting tool comprising:
(a) a frame, said frame comprising of two substantially parallel side rails, a cross member attached to and extending between one end of said side rails, and an end gate attached to and extending between a second end of said side rails;
(b) a substantially flat blade slidably disposed between said side rails, said blade having an edge in the shape of a wide-angled arrow point pointing in the general direction of said end gate;
(c) means for moving said blade toward said end gate, whereby said movement causes said blade to truncate said elongated structural member extending through said frame between said blade and said end gate.

2. The cutting tool of claim 1, wherein said end gate has a pocket extending between said side rails to accommodate said blade when said blade reaches said end gate.

3. The cutting tool of claim 2, wherein said end gate is equipped with a downwardly beveled cutting edge that extends toward said blade from said end gate immediately above said pocket.

4. The cutting tool of claim 3, wherein said end gate is removably secured to said second end of said side rails.

5. The cutting tool as in any of claims 1-4, wherein said edge of said blade is symmetrically double-beveled.

6. A cutting tool for truncating elongated structural members, said cutting tool comprising:
(a) a frame, said frame comprising of two substantially parallel side rails, a cross member attached to and extending between one end of said side rails, and an end gate attached to and extending between a second end of said side rails;
(b) a substantially flat blade slidably disposed between said side rails, said blade having a primary cutting edge and two secondary cutting edges, where said primary cutting edge faces said end gate and is recessed in said blade, and where said two secondary cutting edges face each other on opposite sides of said recessed portion of said blade;
(c) means for moving said blade toward said end gate, whereby said movement causes said blade to truncate said elongated structural member extending through said frame between said blade and said end gate.

7. The cutting tool of claim 6, wherein said end gate has a pocket extending between said side rails to accommodate said blade when said blade reaches said end gate.

8. The cutting tool of claim 7, wherein said end gate is removably secured to said second end of said side rails.

9. The cutting tool as in any of claims 6-8, wherein said primary cutting edge and two secondary cutting edges are symmetrically double-beveled.
